(19) United States
(12) Patent Application Publication
(10) Pub. No.: US 2025/0249739 A1
(43) Pub. Date: Aug. 7, 2025

(54) GEARBOX AND DRIVE UNIT WITH A GEARBOX FOR A VEHICLE

(71) Applicant: ZF Friedrichshafen AG, Friedrichshafen (DE)

(72) Inventors: Johannes Kaltenbach, Friedrichshafen (DE); Thomas Martin, Weissensberg (DE); Fabian Kutter, Kressbronn (DE); Johannes Glückler, Friedrichshafen (DE); Stefan Renner, Bodman-Ludwigshafen (DE); Kai Bornträger, Langenargen (DE)

(73) Assignee: ZF Friedrichshafen AG, Friedrichshafen (DE)

(21) Appl. No.: 19/042,161

(22) Filed: Jan. 31, 2025

(30) Foreign Application Priority Data
Feb. 2, 2024 (DE) 10 2024 200 941.5

(51) Int. Cl. B60K 17/16; B60K 1/00; F16H 63/36

(52) U.S. Cl. CPC B60K 17/16; B60K 1/00; F16H 63/36; B60K 2001/001; F16H 2200/0021; F16H 2200/2007

(57) ABSTRACT

A vehicle gearbox has an input shaft for an electric machine, an output shaft, an interlocking shifting unit having first and second shifting elements, and a single axially displaceable sliding sleeve. First and second planetary gearsets each have a sun shaft, a ring gear shaft, and a web shaft. The first sun shaft, the second sun shaft, and the drive input shaft are connected rotationally fixed to one another, the first ring gear shaft is connected rotationally fixed to a stationary component; and the first web shaft is connected rotationally fixed to the second ring gear shaft. Closing the first shifting element engages a first gear where the first web shaft, second ring gear shaft, and output shaft connected rotationally fixed to one another. Closing the second shifting element engages a second gear where the second web shaft and output shaft are connected rotationally fixed to one another.

### RELATED APPLICATIONS

This application claims the benefit of and right of priority under 35 U.S.C. § 119 to German Patent Application no. 10 2024 200 941.5, filed on 2 Feb. 2024, the contents of which are incorporated herein by reference in its entirety.

### FIELD OF THE DISCLOSURE

The invention relates to a gearbox for a vehicle. In addition, the invention relates to a drive unit for a vehicle, wherein the drive unit comprises an electric machine and a gearbox of the type with a plurality of gears. The invention also relates to a vehicle with such a drive unit.

### BACKGROUND

For example, WO 2021/013 298 A1 discloses a drive device for a motor vehicle. The drive device comprises an electric machine which is functionally connected by way of a driveshaft to a transmission device, the transmission device comprising at least a first and a second planetary gearwheel stage and a differential stage. The first planetary gearwheel stage comprises a first planetary gearset with a plurality of planetary gearwheels, wherein the planetary gearwheels are arranged rotatably on a first planetary gearwheel carrier and mesh with a first sun gear and a first ring gear. The second planetary gearwheel stage comprises a second planetary gearset with a plurality of planetary gearwheels, wherein the planetary gearwheels are arranged rotatably on a second planetary gearwheel carrier and mesh with a second sun gear and a second ring gear. The first and second planetary gearwheel stages are functionally connected to a dual clutch device which comprises a first and a second frictional clutch. The first sun gear and the second sun gear are connected in a rotationally fixed manner. The driveshaft is functionally connected to the two sun gears. The first and second sun gears have the same pitch circle diameter. The first planetary gearwheel carrier can be positionally fixed to a housing by means of a first clutch and the first ring gear can be positionally fixed to the housing by means of a second clutch.

### SUMMARY

The purpose of the present invention is to provide an alternative gearbox for a vehicle. In particular, the gearbox should have a compact structure. This objective is achieved by a gearbox as variously disclosed herein. Advantageous embodiments will be apparent from the description given below and the figures.

According to an embodiment of the invention, a gearbox for a vehicle comprises a driveshaft for the connection of an electric machine, an interlocking shifting unit with at least a first shifting element, a second shifting element, and a single, axially displaceable sliding sleeve, a first planetary gearset with a first sun shaft, a first ring gear shaft, and a first web shaft, and a second planetary gearset with a second sun shaft, a second ring gear shaft, and a second web shaft, wherein the first and second sun shafts and the driveshaft are connected in a rotationally fixed manner, wherein the first ring gear shaft is connected rotationally fixed to a stationary component, wherein the first web shaft and the second ring gear shaft are connected rotationally fixed to one another, wherein when the first shifting element is closed a first gear with a first gear ratio is engaged, wherein in the first gear the first web shaft, the second ring gear shaft and the drive output shaft are connected rotationally fixed to one another, wherein when the second shifting element is closed a second gear with a second gear ratio is engaged, wherein in the second gear the second web shaft and the drive output shaft are connected rotationally fixed to one another. In this connection reference should be made to the embodiments illustrated in FIGS. 2 to 4. In particular, the first web shaft and the second ring gear shaft form a first coupling shaft between the two planetary gearsets, whereas the first son shaft and the second sun shaft form a second coupling shaft between the two planetary gearsets.

In the context of the invention, a “shaft” is understood to be a rotatable component of the transmission by means of which respective components of the transmission are connected to one another in a rotationally fixed manner or by means of which such a connection can be formed by actuating one of the shifting elements. The shaft can thereby connect the components to one another axially or radially or even both axially and radially. Thus, the shaft can also be present as an intermediate component by way of which a particular component can be connected, for example radially. The term “shaft” does not exclude that the components to be connected can be made integrally. In particular, two or more shafts connected rotationally fixed to one another can be made integrally. A “stationary component” is understood to be a component which is fixed in a stationary manner, in particular being rotationally fixed or integrally made with a housing or part of a housing.

According to a further embodiment of the invention, a gearbox for a vehicle comprises a drive input shaft for connection to an electric machine, a drive output shaft, an interlocking shifting unit with at least a first shifting element, a second shifting element, and a single axially displaceable sliding sleeve, a first planetary gearset with a first sun shaft, a first ring gear shaft, and a first web shaft, and a second planetary gearset with a second sun shaft, a second ring gear shaft, and a second web shaft, wherein the first sun shaft, the second sun shaft, and the driveshaft are connected rotationally fixed to one another, wherein the first ring gear shaft is connected rotationally fixed to a stationary component, wherein the second web shaft and the drive output shaft are connected rotationally fixed to one another, wherein when the first shifting element is closed a first gear with a first gear ratio is engaged, wherein in the first gear the first web shaft, the second web shaft, and the drive output shaft are connected rotationally fixed to one another, wherein when the second shifting element is closed a second gear with a second gear ratio is engaged, wherein in the second gear the first web shaft and the second ring gear shaft are connected rotationally fixed to one another. In this connection reference should be made to the embodiments illustrated in FIGS. 5 to 8. In particular, the first sun shaft and the second sun shaft form a coupling shaft between the two planetary gearsets.

A drive unit according to the invention for a vehicle comprises an electric machine and a gearbox according to the invention. Preferably the electric machine is arranged coaxially with the gearbox. The gearbox makes possible the connection of the electric machine so that a drive power can be transmitted via the driveshaft. By way of the drive output shaft the gearbox can be functionally connected either to a differential or to a vehicle wheel. For example, a single drive unit is used in an electric drive axle for an electric vehicle, and in that case the drive output shaft is functionally connected to a differential. Alternatively, two drive units can be used in an electric drive axle for an electric vehicle, and in that case the respective drive output shaft is functionally connected to the associated vehicle wheel of the drive axle. Depending on the embodiment concerned, the gearbox has two or three gears which are engaged by means of the interlocking shifting unit, whereby the energy efficiency of electric vehicles is increased.

The shifting elements of the interlocking shifting unit are in the form of gear shifting elements and are therefore designed for the engagement of gears. To engage the first gear, the first shifting element can be actuated or closed. To engage the second gear the second shifting element can be actuated or closed. Optionally a third shifting element can be provided, such that to engage the third gear the third shifting element can be actuated or closed. A “shifting element” is a shiftable device which in a closed condition connects two shafts to one another in a rotationally fixed manner, and in an open condition decouples the two shafts from one another. The two shafts can then rotate relative to one another.

According to the invention, the first shifting element and the second shifting element form a shifting unit with three shift positions, wherein the shifting unit comprises a single axially displaceable sliding sleeve. The sliding sleeve can be moved to its respective shift positions by means of a single actuator. Preferably, between two gear-engaging positions the shifting unit has a neutral position, so that the three shift positions include two gear-engaging positions and one neutral position. In a neutral position, two shafts are decoupled from one another by the shifting unit, whereas the sliding sleeve is then in rotating engagement with only one of the shafts. In particular, the actuator moves the sliding sleeve to its respective shift position and thereby engages two gears in sequence, whereas a change between the gears always entails passing through the neutral position. The sliding sleeve is designed to operate with interlock and comprises interlocking claws which in the respective gear-engaging position co-operates with respective corresponding claw teeth by interlocking with them in order to produce a rotationally fixed connection between two shafts. Thus, the claw teeth with which the sliding sleeve co-operates in an interlocking manner can be regarded as a shifting element. Preferably, the shifting unit comprises an unsynchronized claw clutch, so that all the shifting elements are in the form of interlocking shifting elements. By virtue of interlocking shifting element the efficiency of the gearbox can be increased since drag losses are reduced. In particular, interlocking shifting elements are more compact and have cost advantages compared with frictional shifting elements. The use of the sliding sleeve for engaging the gears further increases the compactness.

In a preferred embodiment, the interlocking shifting unit also comprises a third shifting element, such that in the closed state of the third shifting element a third gear in the form of a direct gear with a third gear ratio is engaged. Thus, the third shifting element is also a gear-engaging shifting element, such that to engage the third gear only the third shifting element can be actuated or closed. The third gear is in the form of a direct gear, and owing to the block rotation of the two planetary gearsets, is characterized by good efficiency and no gearteeth losses. For example, in the third gear the second planetary gearset is blocked since two of the three shafts of the second planetary gearset, namely, the second sun shaft, the second web shaft, and the second ring gear shaft, are connected to one another. In that way the direct gear is produced with a gear ratio of 1. Alternatively, in the third gear the drive input shaft and the drive output shaft are connected rotationally fixed to one another, whereby the direct gear is produced with a gear ratio of 1.

According to a preferred embodiment, the first shifting element, the second shifting element and the third shifting element form a shifting unit with five shift positions, such that the shifting unit comprises a single axially displaceable sliding sleeve. The sliding sleeve can be moved axially to the respective shift positions by means of a single actuator. Preferably, the shifting unit has a neutral position between two gear-engaging positions in each case, so that with five shift positions three gear-engaging positions and two neutral positions are provided. In a neutral position two shafts are decoupled from one another by the shifting device, so that then the sliding sleeve is rotationally engaged with only a single shaft. In particular, the actuator moves the sliding sleeve to the respective shift position and thereby engages three gears sequentially.

In an embodiment, the gearbox also comprises a differential in the form of an integral differential, with a differential input shaft which is connected rotationally fixed to the drive output shaft, two differential output shafts and two radially nested planetary gearsets, the differential and the two planetary gearsets being arranged on a common rotation axis. The drive power fed into the differential gear system is distributed between the differential output shafts and transmitted to the drive wheels of the axle. The differential output shafts are designed to be functionally connected to the drive wheels of the vehicle. The differential output shaft concerned can be connected to its associated vehicle wheel either directly and immediately, or indirectly or intermediately by way of a joint, a joint shaft and/or a wheel hub.

In particular, the two planetary gearsets of the integral differential are nested radially. This increases the compactness of the gearbox. An “integral differential” is understood to be a differential with a first planetary gearset and a second planetary gearset functionally connected to the first planetary gearset. The first planetary gearset of the integral differential is on the one hand drivingly connected to the drive output shaft, and on the other hand drivingly connected to the second planetary gearset of the integral differential and at least indirectly to the first differential output shaft. The second planetary gearset of the integral differential is also drivingly connected to the second differential output shaft and is supported on a stationary component, specifically on a housing component. By virtue of such a differential the input torque applied in the integral differential can be distributed variably and in a defined ratio to the two differential output shafts. In particular the input torque is transmitted equally between the two differential output shafts.

When the drive output rotation speeds of the output shafts are identical the integral differential does not comprise any teeth that rotate in a block or without any rolling movement. Accordingly, independently of the drive output rotation speeds of the output shafts there is always a relative movement of the components of the integral differential that mesh with one another. With an integral differential the sum of the two wheel torques is not conjoined or combined in one component, but rather, a drive power in the integral differential is divided and passed on to the differential output shafts functionally connected thereto in accordance with the design of the first and second planetary gearsets. Consequently, since the torques involved are comparatively small the components of the integral differential can be made slimmer. Furthermore, the number of components is reduced and weight is saved. By virtue of such an integral differential, the two functions of torque conversion and torque distribution, which as a rule are performed by two separate assemblies, are obtained from a single integral assembly. Thus, the integral differential is a combined transmission and differential gear system which on the one hand converts torques and on the other hand distributes them to the differential output shafts.

According to an embodiment, the second planetary gearset is arranged on the first planetary gearset axially adjacent thereto, whereby the sliding sleeve is arranged at least partially radially nested at the outer periphery of the second planetary gearset. This makes the gearbox axially more compact. Preferably the second planetary gearset is arranged at least partially or even completely radially inside the sliding sleeve. In other words, the sliding sleeve and the first planetary gearset are arranged axially overlapping at least partially, or completely.

A vehicle according to the invention comprises at least one gearbox according to the invention and/or a drive unit according to the invention. The above definitions and explanations relating to technical effects, advantages and advantageous embodiments of the gearbox according to the invention and the drive unit according to the invention obviously also apply to the vehicle according to the invention.

### BRIEF DESCRIPTION OF THE DRAWINGS

Advantageous embodiments of the invention, which are explained in what follows, are illustrated in the drawings in which the same or similar elements are denoted by the same indexes, and which show:

FIG. 1: A very generalized and schematic view of a vehicle with a drive axle comprising an electric machine and a gearbox according to the invention;

FIG. 2: A very generalized and schematic view of a drive unit according to the invention with a gearbox, according to a first embodiment;

FIG. 3: A very generalized and schematic view of a drive unit according to the invention with a gearbox, according to a second embodiment;

FIG. 4: A very generalized and schematic view of a drive unit according to the invention with a gearbox, according to a third embodiment;

FIG. 5: A very generalized and schematic view of a drive unit according to the invention with a gearbox, according to a fourth embodiment;

FIG. 6: A very generalized and schematic view of a drive unit according to the invention with a gearbox, according to a fifth embodiment;

FIG. 7: A very generalized and schematic view of a drive unit according to the invention with a gearbox, according to a sixth embodiment, and

FIG. 8: A very generalized and schematic view of a drive unit according to the invention with a gearbox, according to a seventh embodiment.

### DETAILED DESCRIPTION

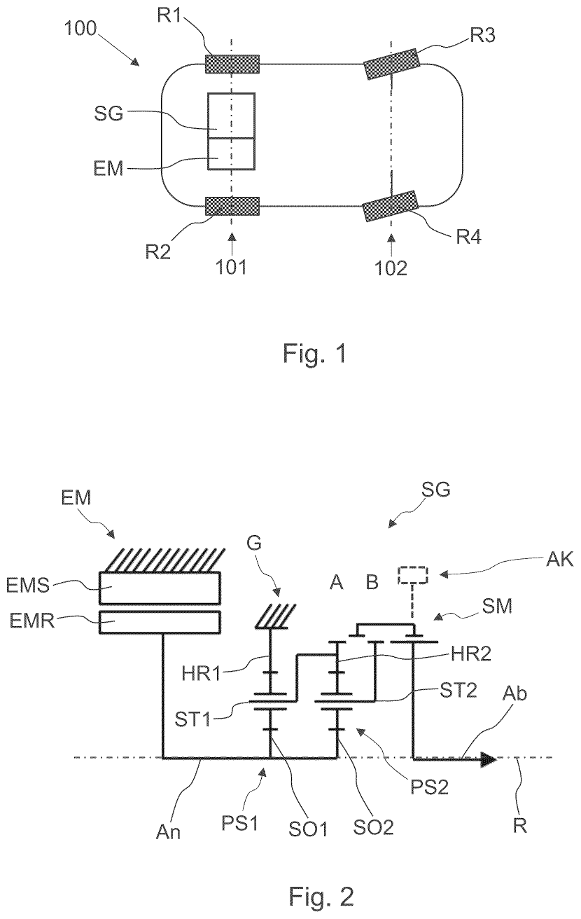

FIG. 1 shows a vehicle 100 with a first axle 101 having two vehicle wheels R1, R2 and a second axle 102 having two further vehicle wheels R3, R4. In the present case the first axle 101 is designed as the rear drive input axle of the vehicle 100 and is equipped with a drive unit according to the invention. The drive unit comprises an electric machine EM designed to generate a drive power, and a gearbox SG with a plurality of gears. Thus, the vehicle 100 is in the form of an electric vehicle, i.e., a vehicle that can be powered electrically. The drive unit is arranged transversely to the longitudinal axis of the vehicle and is drivingly connected to the vehicle wheels R1, R2 of the first axle 101. In the present case no further drive unit is arranged on the second axle 102, i.e., the front axle of the vehicle 100, whereby costs, weight, and fitting space are saved. Alternatively, instead of on the rear axle the drive unit could be fitted on the front axle of the vehicle 100. To produce an all-wheel drive system a further drive unit could be arranged on the second axle 102 and drivingly connected to the vehicle wheels R3, R4 of that axle 102.

FIG. 2 shows a drive unit for a vehicle with a gearbox SG according to a first embodiment. The gearbox SG is connected by a shaft An to an electric machine EM which comprises a stator EMS fixed to the housing and a rotor EMR that can move in rotation. The electric machine EM is arranged coaxially with the gearbox SG. Thus, the gearbox SG and the electric machine EM form the electric drive unit.

The gearbox SG comprises an interlocking shifting unit with a first shifting element A, a second shifting element B, and a single axially displaceable sliding sleeve SM. In addition, the gearbox SG comprises a first planetary gearset PS1 and a second planetary gearset PS2. The first planetary gearset PS1 comprises three shafts, namely, a first sun shaft SO1, a first ring gear shaft HR1, and a first web shaft ST1. The first web shaft ST1 carries a plurality of planetary gearwheels which mesh, i.e., are in tooth engagement with the first sun shaft SO1 and with the first ring gear shaft HR1. The second planetary gearset PS2 also comprises three shafts, namely, a second sun shaft SO2, a second ring gear shaft HR2, and a second web shaft ST2. The second web shaft ST2 carries a plurality of planetary gearwheels which mesh, i.e., are in tooth engagement with the second sun shaft SO2 and with the second ring gear shaft HR2. Furthermore, the two planetary gearsets PS1 and PS2 are arranged axially adjacent to one another so that the sliding sleeve SM1 is radially nested at the outer periphery of the second planetary gearset PS2 in order to save fitting space and thereby increase the compactness.

The first sun shaft SO1, the second sun shaft SO2, and the drive input shaft An are connected in a rotationally fixed manner. The drive power of the electric machine EM is introduced into the gearbox SG by way of the drive input shaft An. Furthermore, the first ring gear shaft HR1 is connected rotationally fixed to a stationary component in the form of a housing G. The first web shaft ST1 and the second ring gear shaft HR2 are connected rotationally fixed to one another. By means of the first shifting element A, the first web shaft ST1 and the second ring gear shaft HR2 can be connected rotationally fixed to the drive output shaft Ab. By means of the second shifting element B the second web shaft ST2 can be connected rotationally fixed to the drive output shaft Ab. The drive output shaft Ab can be drivingly connected to at least one drive wheel of the vehicle, either indirectly by way of a differential, or directly, this being indicated in the present case by an arrow on the drive output shaft Ab. For example, a drive unit can be provided for each drive wheel of the vehicle. The gearbox SG has a rotational axis of symmetry R that coincides with the drive input shaft An and the drive output shaft Ab. Like the two planetary gearsets PS1, PS2 the electric machine BM is arranged coaxially with the drive input shaft An and the drive output shaft Ab. The embodiments shown in FIGS. 2 through 8 show only the “upper” half of the drive unit concerned, the “lower” half (not shown) being symmetrical to the “upper” half.

The interlocking shifting unit with the two shifting elements A, B has three shift positions, these three shift positions being obtained by axial displacement of the sliding sleeve SM. The sliding sleeve SM comprises claw-type shifting elements and can be moved axially to the required shift position by means of a single actuator AK. Thus, all three of the shift positions of the shifting unit are arranged in line and consist of two gear-engaging positions and one neutral position, the neutral position being arranged between the two gear-engaging positions. Gears one and two are engaged one after the other or sequentially by moving the sliding sleeve in an axial direction past the neutral position. This not only saves weight and components, but also saves costs, fitting space and assembly effort.

The first gear is engaged when the sliding sleeve SM is in a first gear-engaging position, i.e., a first shift position. In its actuated or closed state, i.e., when the sliding sleeve SM is in its first shift position, the first shifting element A connects the first web shaft ST1 and the second ring gear shaft HR2 to the drive output shaft Ab in order to engage the first gear. Thus, the first gear is engaged by actuating the sliding sleeve SM so as to close only the first shifting element A.

The first gear is disengaged by moving the sliding sleeve axially to a first neutral position, i.e., to a second shift position, in this case to the right. In the second shift position of the sliding sleeve SM the sliding sleeve SM is only in rotational engagement with the drive output shaft Ab. In this neutral position both shifting element A and B are open, so that the drive machine connected to the drive input shaft An and the two planetary gearsets PS1 and PS2 are decoupled from the drive output shaft Ab and they do not give rise to any losses, for example due to rotating bearings. In this neutral position, the electric machine EM can synchronize the target gear. In the present case FIG. 2 shows this second shift position of the sliding sleeve SM.

The second gear is engaged by moving the sliding sleeve SM to a second gear-engaging position, i.e., to a third shift position, in this case farther to the right. In its actuated or closed state, i.e. in the third shift position of the sliding sleeve SM, the second shifting element B connects the second web shaft ST2 and the drive output shaft Ab in order to engage the second gear. Thus, the second gear is engaged by actuating the sliding sleeve SM and closing only the second shifting element B.

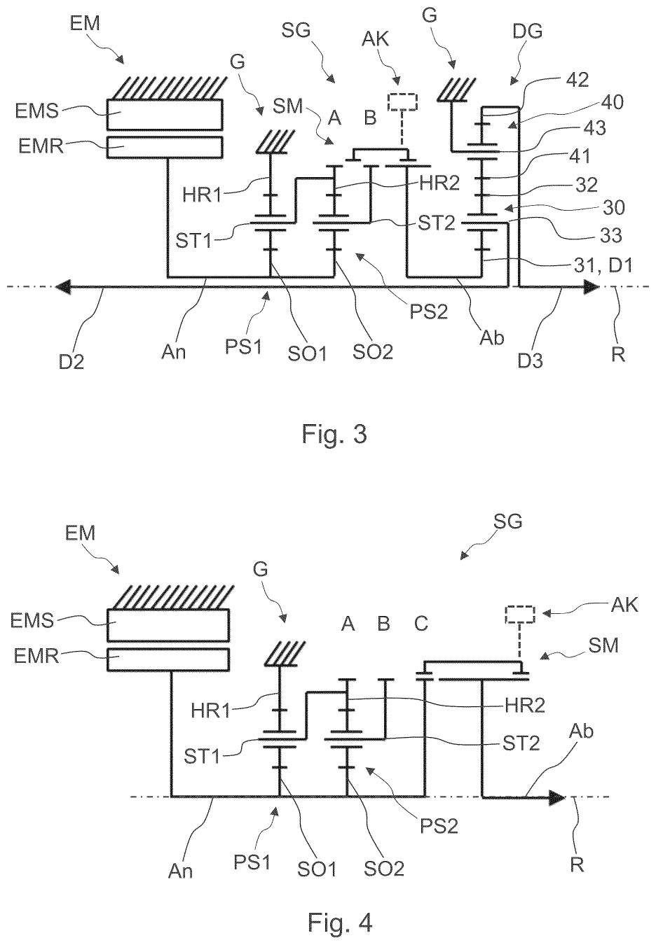

FIG. 3 shows a second embodiment of the gearbox SG according to the invention, which is connected to an electric machine EM by way of the drive input shaft An. The electric drive unit according to FIG. 3 formed in that way corresponds essentially to the electric drive unit according to FIG. 2, the difference between these two embodiments consisting in the arrangement of a differential DG on the axis of symmetry R. The differential DG is designed as an integral differential with a first planetary gearset 30 and a second planetary gearset 40. The integral differential increases the final gear ratio and at the same time enables a differential function. The differential DG can also be added to the other example embodiments which have no differential.

Depending on what is demanded of the integral differential, in particular the gear ratio of the integral differential required, the two planetary gearsets 30 and 40 of the integral differential can be either arranged axially next to one another or radially one above the other, i.e., radially stacked. In the present case, the two planetary gearsets 30, 40 of the integral differential are arranged radially one above the other, whereby axial fitting space is saved. A sun gear 31 of the first planetary gearset 30 of the integral differential forms the differential input shaft D1 of the integral differential and is connected rotationally fixed to the drive output shaft Ab.

The drive output from the integral differential takes place via the two differential output shafts D2 and D3, wherein a web shaft 33 of the first planetary gearset 30 of the integral differential is connected rotationally fixed to the first differential output shaft D2 and wherein a ring gear 42 of the second planetary gearset 40 of the integral differential is connected rotationally fixed to the second differential output shaft D3. The sun gear 41 of the second planetary gearset 40 of the integral differential is connected rotationally fixed to the ring gear 32 of the first planetary gearset 30 of the integral differential and in the present case is made integrally as an intermediate gearwheel with internal and external teeth. The web shaft 43 of the second planetary gearset 40 of the integral differential carries a plurality of planetary gearwheels which mesh with the sun gear 41 and the ring gear 42, and is connected rotationally fixed to a stationary component in the form of the housing. In addition, the web shaft 33 of the first planetary gearset 30 of the integral differential carries a plurality of planetary gearwheels which mesh with the sun gear 31 and with the ring gear 32.

By means of the first planetary gearset 30 of the integral differential, a first drive output torque can be transmitted to the first differential output shaft D2. A supporting torque of the first planetary gearset 30 acting in opposition to the first drive output torque is transmitted to the second planetary gearset 40 and can be converted in the second planetary gearset 40 in such manner that a second drive output torque corresponding to the first drive output torque can be transmitted to the second differential output shaft D3. In other words, by means of the integral differential a drive power fed in by way of the sun gear 31 of the first planetary gearset 30 is divided between the two differential output shafts D2, D3. In this case the first differential output shaft D2 extends through the gearbox SG and the electric machine EM. In other respects, the example embodiment according to FIG. 3 corresponds to the example embodiment of FIG. 2, to which reference can be made.

FIG. 4 shows a third embodiment of the gearbox SG according to the invention, which is connected by the drive input shaft An to an electric machine EM. The electric drive unit so formed, shown in FIG. 4, corresponds essentially to the electric drive unit according to FIG. 2, the difference between these two embodiments consisting in the structure of the shifting unit. In this case the interlocking shifting unit also comprises a third shifting element C. With the third shifting element C a third gear in the form of a direct gear with a third gear ratio can be engaged. In its closed state the third shifting element C connects the drive output shaft An and the first and second sun shafts SO1, SO2 connected rotationally fixed to it, to the drive output shaft Ab.

The first shifting element A, the second shifting element B and the third shifting element C are thus combined into a shifting unit with five shift positions, wherein the shifting unit comprises a single axially displaceable sliding sleeve SM which can be moved to five shift positions. The sliding sleeve SM has claw shifting elements and can be moved axially by means of a single actuator AK to the shift position required. Thus, all five of the shift positions of the shifting unit are arranged in line and consist of three gear-engaging positions and two neutral positions, in each case with a neutral position between two gear-engaging positions. The three gears are engaged one after another or sequentially by moving the sliding sleeve SM in an axial direction past the neutral positions. In that way not only are weight and components saved, but also costs, fitting space and assembly effort. The first three shift positions of the sliding sleeve SM according to this third embodiment of the gearbox SG correspond exactly to the first three shift positions of the sliding sleeve SM in the first embodiment of the gearbox SG.

The second gear is disengaged if the sliding sleeve SM is moved axially to a second neutral position, i.e., to the fourth shift position. In the second neutral position the sliding sleeve SM is in rotational engagement only with the drive output shaft Ab. In this neutral position all three of the shifting elements A, B and C are open, so that the drive machine connected to the drive input shaft An, as well as the two planetary gearsets PS1 and PS2, is decoupled from the drive output shaft Ab and there are no losses, for example due to rotating bearings. In this neutral position the electric machine EM can synchronize the target gear.

The third gear is engaged if the sliding sleeve SM is moved axially to a third gear-engaging position, i.e., to the fifth shift position. In this fifth shift position of the sliding sleeve SM the third shifting element C connects the drive input shaft An and the two sun shafts SO1, SO2 to the drive output shaft Ab, in order to engage the third gear. The third gear is in the form of a direct gear with a gear ratio of 1 and gives rise to no tooth losses since the drive input shaft An is connected directly to the drive output shaft Ab. In the present case FIG. 4 shows the fifth shift position of the sliding sleeve SM. In other respects, the example embodiment according to FIG. 4 corresponds to the example embodiment shown in FIG. 2, to which reference can be made.

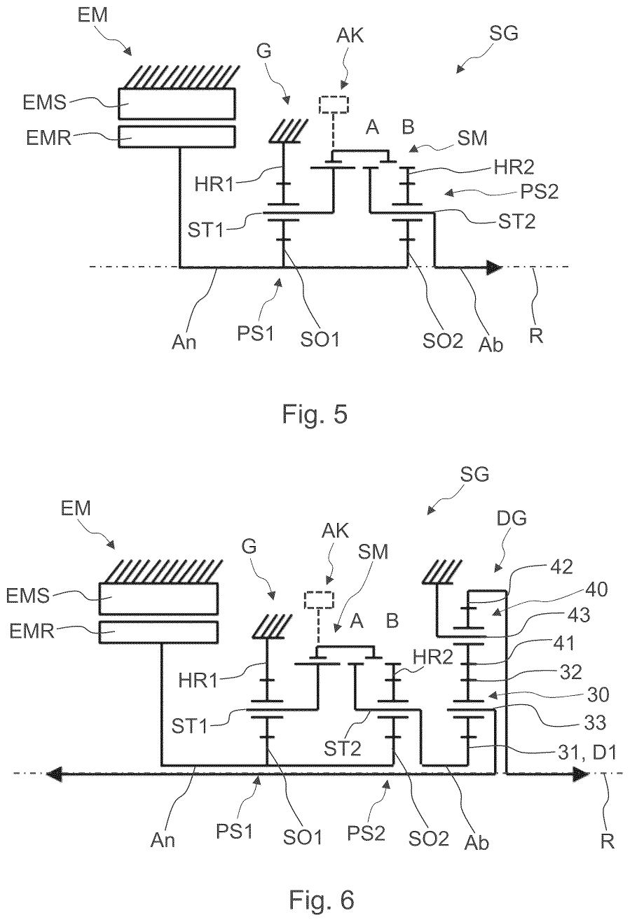

FIG. 5 shows a fourth embodiment of a gearbox SG according to the invention, which is connected by way of the drive input shaft An to an electric machine EM. The electric drive unit so formed, shown in FIG. 5, corresponds essentially to the electric drive unit according to FIG. 2, the difference between these two embodiments consisting in the connection of the two planetary gearsets PS1, PS2, specifically by way of the shifting unit. Also in this embodiment, the first sun shaft SO1, the second sun shaft SO2, and the drive input shaft An are connected in a rotationally fixed manner and the first ring gear shaft HR1 is connected rotationally fixed to the stationary component in the form of the housing G. However, the second web shaft ST2 and the drive output shaft Ab are connected rotationally fixed to one another. In the closed state of the first shifting element A a first gear with a first gear ratio is engaged, wherein in the first gear the first web shaft ST1, the second web shaft ST2 and the drive output shaft Ab are in rotationally fixed connection. In the closed state of the second shifting element B, a second gear with a second gear ratio is engaged, and in this second gear the first web shaft ST1 and the second ring gear shaft HR2 are connected rotationally fixed to one another.

In this embodiment as well, the interlocking shifting unit with the two shifting elements A and B has three shift positions, these three shift position being obtained by moving the sliding sleeve SM axially. The sliding sleeve has claw shifting elements and can be moved axially to the required shift position by a single actuator AK. Thus, all three shift positions of the sliding sleeve are arranged in line and consist of two gear-engaging positions and a neutral position, the neutral position being arranged between the two gear-engaging positions. Gears one and two are engaged one after the other or sequentially by moving the sliding sleeve SM in an axial direction past the neutral position. In that way, not only weight and components, but also costs, fitting space and assembly effort are saved.

The first gear is engaged when the sliding sleeve SM is located in a first gear-engaging position, i.e., in a first shift position. In its actuated or closed state, i.e., in the first shift position of the sliding sleeve SM, the first shifting element A connects the first web shaft ST1, the second web shaft ST2 and the drive output shaft Ab in order to engage the first gear. Thus, by actuating the sliding sleeve SM and closing only the first shifting element A the first gear is engaged. In the first gear when the first shifting element A is closed, only the first planetary gearset PS1 is active, whereas the second planetary gearset PS2 is free from load.

The first gear is disengaged by moving the sliding sleeve SM axially to a first neutral position, i.e., to the second shift position, in this case to the right. In the second shift position of the sliding sleeve SM, the sliding sleeve SM is in rotational engagement only with the first web shaft ST1. In this neutral position, both of the shifting elements A, B are open, so that the electric machine EM can synchronize the target gear. This second shift position of the sliding sleeve SM is shown in FIG. 5.

The second gear is engaged by moving the sliding sleeve SM to a second gear-engaging position, i.e., to a third shift position, in this case farther to the right. In its actuated or closed state, i.e., in the third shift position of the sliding sleeve SM, the second shifting element B connects the first web shaft ST1 and the second ring gear shaft HR2 in order to engage the second gear. By actuating the sliding sleeve SM and closing only the second shifting element B, the second gear is engaged. In other respects, the example embodiment according to FIG. 5 corresponds to the example embodiment shown in FIG. 2, to which reference can be made.

FIG. 6 shows a fifth embodiment of the gearbox according to the invention, which is connected to an electric machine EM by way of the drive input shaft An. The electric drive unit so formed, shown in FIG. 6, corresponds essentially to the electric drive unit according to FIG. 5, the difference between these two embodiments consisting in the arrangement of a differential DG on the axis of symmetry R. The differential DG is in the form of an integral differential with a first planetary gearset 30 and a second planetary gearset 40. The integral differential increases the final gear ratio and at the same time enables a differential function. The differential DG can also be added to the other example embodiments which have no differential. The differential DO corresponds exactly to the differential DG according to FIG. 3, to which reference can be made in order to avoid repetitions. In other respects, the example embodiment according to FIG. 6 corresponds to the example according to FIG. 5, to which reference can be made.

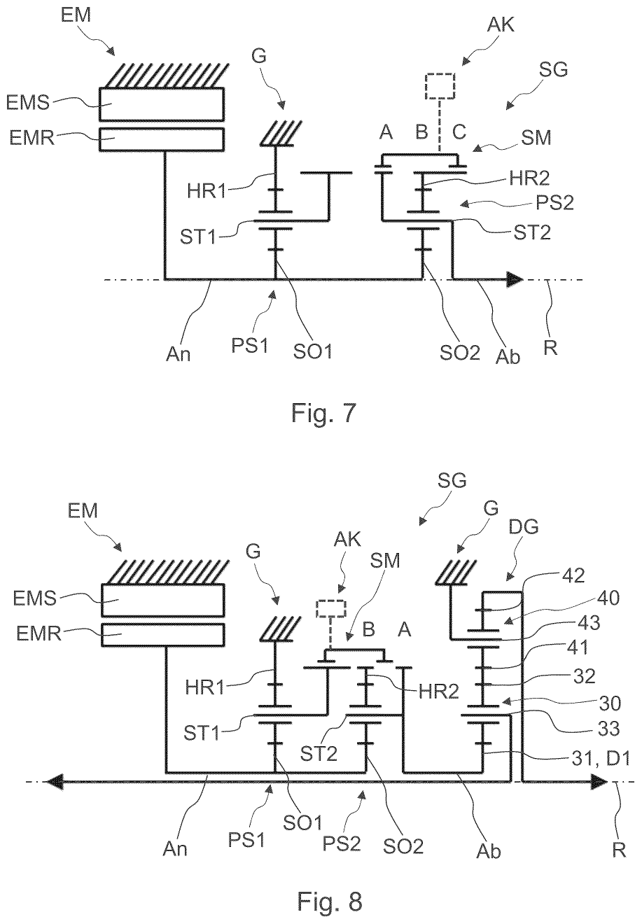

FIG. 7 shows a sixth embodiment of the gearbox SG according to the invention, which is connected to an electric machine EM by way of the drive input shaft An. The electric drive unit so formed, shown in FIG. 7, corresponds essentially to the electric drive unit according to FIG. 5, the difference between these two embodiments consisting in the structure of the shifting unit. In this case the interlocking shifting unit also comprises a third shifting element C. By means of the third shifting element C a third gear in the form of a direct gear with a third gear ratio can be engaged. In its closed state the third shifting element C connects the second ring gear shaft HR2 to the second web shaft ST2 and the drive output shaft Ab connected rotationally fixed thereto. In that way the second planetary gearset PS2 is blocked, whereby a gear ratio of 1 is obtained.

The first shifting element A, the second shifting element B and the third shifting element C are combined to form a shifting unit with five shift positions, wherein the shifting unit comprises a single axially displaceable sliding sleeve SM with which the five shift positions can be obtained. The sliding sleeve SM has claw shifting elements and can be moved axially to the required shift position by means of a single actuator AK. Thus, all five of the shift positions of the shifting unit are arranged in line and consist of three gear-engaging position and two neutral positions, with a respective neutral position arranged between two gear-engaging positions in each case. The three gears are engaged one after the other or sequentially by moving the sliding sleeve SM in an axial direction past the neutral positions. This saves not only weight and components, but also costs, fitting space and assembly effort. The first three shift positions of the sliding sleeve SM in this sixth embodiment correspond exactly to the first three shift positions of the sliding sleeve SM in the fourth embodiment of the gearbox SG.

The second gear is disengaged by moving the sliding sleeve SM to a second neutral position, i.e. to the fourth shift position. In the second neutral position the sliding sleeve SM is in rotational engagement only with the second ring gear shaft HR2. In this neutral position all three of the shifting elements A, B and C are open, so that the electric machine EM can synchronize the target gear.

The third gear is engaged by moving the sliding sleeve SM to a third gear-engaging position, i.e., to a fifth shift position. In the fifth shift position of the sliding sleeve SM the shifting element C connects the drive output shaft Ab and the second web shaft ST2 to the second ring gear shaft HR2, in order to engage the third gear. The third gear is a direct gear with a gear ratio of 1 and does not give rise to any tooth losses since the second planetary gearset PS2 is blocked. In the present case FIG. 7 shows this fifth shift position of the sliding sleeve SM. In other respects, the example embodiment according to FIG. 7 corresponds to the example embodiment according to FIG. 5, to which reference can be made.

FIG. 8 shows a seventh embodiment of the gearbox SG according to the invention, which is connected to an electric machine EM by way of the drive input shaft An. The electric drive unit so formed, shown in FIG. 8, corresponds essentially to the electric drive unit according to FIG. 6, the difference between these two embodiments consisting in the arrangement of the shifting unit. In this case the axial sequence of the first shifting element A and the second shifting element B in the shifting unit has been interchanged. The connection of the first web shaft ST1 to the second web shaft ST2 by means of the first shifting element A does not take place as in the embodiment according to FIG. 6 adjacently between the two planetary gearsets PS1, PS2, but away from the second planetary gearset PS2. Functionally, there is no difference from the embodiment according to FIG. 6. The advantages and disadvantages are only of a design nature. Furthermore, the differential DG is only optional and in an alternative embodiment can even be omitted. In other respects, the example embodiment according to FIG. 8 corresponds to the example embodiment according to FIG. 6, to which reference can be made.

### INDEXES

100 Vehicle
101 First axle
102 Second axle
R1 Vehicle wheel
R2 Vehicle wheel
R3 Vehicle wheel
R4 Vehicle wheel
An Drive input shaft
Ab Drive output shaft
SG Gearbox
EM Electric machine
EMS Stator of the electric machine
EMR Rotor of the electric machine
SR1 First spur gear stage
SR2 Second spur gear stage
PS1 First planetary gearset
SO1 First sun shaft
HR1 First ring gear shaft
ST1 First web shaft
PS2 Second planetary gearset
SO2 Second sun shaft
HR2 Second ring gear shaft
ST2 Second web shaft
AK Actuator
G Housing
R Axis of symmetry
DG Differential
D1 Differential input shaft
D2 First differential output shaft
D3 Second differential output shaft
30 First planetary gearset
31 Sun gear of the first planetary gearset
32 Ring gear of the first planetary gearset
33 Web shaft of the first planetary gearset
40 Second planetary gearset
41 Sun gear of the second planetary gearset
42 Ring gear of the second planetary gearset
43 Web shaft of the second planetary gearset
SM Sliding sleeve
A First shifting element
B Second shifting element
C Third shifting element

1. A gearbox (SG) for a vehicle (100), comprising:
a drive input shaft (An) for the connection of an electric machine (EM);
a drive output shaft (Ab);
an interlocking shifting unit with at least a first shifting element (A), a second shifting element (B), and a single axially displaceable sliding sleeve (SM);
a first planetary gearset (PS1) with a first sun shaft (SO1), a first ring gear shaft (HR1), and a first web shaft (ST1); and
a second planetary gearset (PS2) with a second sun shaft (SO2), a second ring gear shaft (HR2), and a second web shaft (ST2);
wherein the first sun shaft (SO1), the second sun shaft (SO2), and the drive input shaft (An) are connected in a rotationally fixed manner;
wherein the first ring gear shaft (HR1) is connected rotationally fixed to a stationary component;
wherein the first web shaft (ST1) and the second ring gear shaft (HR2) are connected rotationally fixed to one another;
wherein in the closed state of the first shifting element (A) a first gear with a first gear ratio is engaged, such that in the first gear the first web shaft (ST1), the second ring gear shaft (HR2) and the drive output shaft (Ab) are connected rotationally fixed to one another; and
wherein in the closed state of the second shifting element (B) a second gear with a second gear ratio is engaged, such that in the second gear the second web shaft (ST2), the second ring gear shaft (H2) and the drive output shaft (Ab) are connected rotationally fixed to one another.

2. A gearbox (SG) for a vehicle (100), comprising:
a drive input shaft (An) for the connection of an electric machine (EM);
a drive output shaft (Ab);
an interlocking shifting unit with at least a first shifting element (A), a second shifting element (B), and a single axially displaceable sliding sleeve (SM);
a first planetary gearset (PS1) with a first sun shaft (SO1), a first ring gear shaft (HR1), and a first web shaft (ST1); and
a second planetary gearset (PS2) with a second sun shaft (SO2), a second ring gear shaft (HR2), and a second web shaft (ST2);
wherein the first sun shaft (SO1), the second sun shaft (SO2), and the drive input shaft (An) are connected in a rotationally fixed manner;
wherein the first ring gear shaft (HR1) is connected rotationally fixed to a stationary component;
wherein the second web shaft (ST2) and the drive output shaft (Ab) are connected rotationally fixed to one another;
wherein in the closed state of the first shifting element (A) a first gear with a first gear ratio is engaged, such that in the first gear the first web shaft (ST1), the second web shaft (ST2), and the drive output shaft (Ab) are connected rotationally fixed to one another; and
wherein in the closed state of the second shifting element (B) a second gear with a second gear ratio is engaged, such that in the second gear the first web shaft (ST1) and the second ring gear shaft (HR2) are connected rotationally fixed to one another.

3. The gearbox (SG) according to claim 1, wherein the interlocking shifting unit has two gear-engaging positions and a neutral position, the neutral position being arranged between the two gear-engaging positions.

4. The gearbox (SG) according to claim 1, wherein the interlocking shifting unit comprises a third shifting element (C), such that in the closed state of the third shifting element (C) a third gear in the form of a direct gear with a third gear ratio is engaged.

5. The gearbox (SG) according to claim 4, wherein the shifting unit has three gear-engaging position and two neutral positions, such that between each pair of gear-engaging positions there is a neutral position.

6. The gearbox (SG) according to claim 1, further comprising a differential (DG) in the form of an integral differential, with a differential input shaft (D1) which is connected rotationally fixed to the drive output shaft (Ab), two differential output shafts (D2, D3) and two radially nested planetary gearsets (30, 40), wherein the differential (DG) and the two planetary gearsets (PS1, PS2) are arranged on a common rotation axis (R).

7. The gearbox (SG) according to claim 1, wherein the second planetary gearset (PS2) is arranged on the first planetary gearset (PS1) axially adjacent thereto, and the sliding sleeve (SM) is arranged at the outer periphery of the second planetary gearset (PS2).

8. A drive unit for a vehicle, comprising an electric machine (EM) and the gearbox (SG) according to claim 1.

9. The drive unit according to claim 8, wherein the electric machine (EM) is arranged coaxially with the gearbox (SG).

10. A vehicle (100) comprising at least one gearbox (SG) according to claim 1.

11. The gearbox (SG) according to claim 2, wherein the interlocking shifting unit has two gear-engaging positions and a neutral position, the neutral position being arranged between the two gear-engaging positions.

12. The gearbox (SG) according to claim 2, wherein the interlocking shifting unit comprises a third shifting element (C), such that in the closed state of the third shifting element (C) a third gear in the form of a direct gear with a third gear ratio is engaged.

13. The gearbox (SG) according to claim 12, wherein the shifting unit has three gear-engaging position and two neutral positions, such that between each pair of gear-engaging positions there is a neutral position.

14. The gearbox (SG) according to claim 2, further comprising a differential (DG) in the form of an integral differential, with a differential input shaft (D1) which is connected rotationally fixed to the drive output shaft (Ab), two differential output shafts (D2, D3) and two radially nested planetary gearsets (30, 40), wherein the differential (DG) and the two planetary gearsets (PS1, PS2) are arranged on a common rotation axis (R).

14. The gearbox (SG) according to claim 2, wherein the second planetary gearset (PS2) is arranged on the first planetary gearset (PS1) axially adjacent thereto, and the sliding sleeve (SM) is arranged at the outer periphery of the second planetary gearset (PS2).

15. A drive unit for a vehicle, comprising an electric machine (EM) and the gearbox (SG) according to claim 2.

16. The drive unit according to claim 15, wherein the electric machine (EM) is arranged coaxially with the gearbox (SG).

17. A vehicle (100) comprising at least one gearbox (SG) according to claim 2.
